(19) United States
(12) Patent Application Publication
(10) Pub. No.: US 2021/0124229 A1
(43) Pub. Date: Apr. 29, 2021

(54) APPARATUS FOR REGIONALLY CHANGING AN OPTICAL PROPERTY AND METHOD FOR PROVIDING THE SAME

(71) Applicant: Technische Universität Kaiserslautern, Kaiserslautern (DE)

(72) Inventors: Egbert OESTERSCHULZE, Kaiserslautern (DE); Carsten KORTZ, Otterberg (DE)

(21) Appl. No.: 17/143,292

(22) Filed: Jan. 7, 2021

Related U.S. Application Data
(63) Continuation of application No. PCT/EP2019/068891, filed on Jul. 12, 2019.

(30) Foreign Application Priority Data
Jul. 13, 2018 (DE) 102018211715.2

(51) Int. Cl. G02F 1/155; G02F 1/163

(52) U.S. Cl. CPC G02F 1/155; G02F 2001/1557; G02F 2202/36; G02F 1/163

(57) ABSTRACT

An apparatus for regionally changing an optical property includes a first electrode and a second electrode including a structuring into at least a first electrode region and in a second electrode region, wherein an intermediate region is arranged between the first electrode region and the second electrode region. The apparatus includes an active material arranged between the first electrode and the second electrode and configured to change the optical property on the basis of an electrical potential difference between the first electrode and the second electrode. The active material forms a continuous layer that covers at least a sub-region of the first electrode region and a sub-region of the second electrode region and that is arranged in the intermediate region.

### CROSS-REFERENCES TO RELATED APPLICATIONS

This application is a continuation of copending International Application No. PCT/EP2019/068891, filed Jul. 12, 2019, which is incorporated herein by reference in its entirety, and additionally claims priority from German Application No. DE 10 2018 211 715.2, filed Jul. 13, 2018, which is incorporated herein by reference in its entirety.

### BACKGROUND OF THE INVENTION

The present invention relates to an apparatus for regionally changing an optical property and to a method for providing the same. In addition, the present invention relates to an electrochromic iris that is continuously switchable in segments across the whole surface.

Irides are components that may be used to control the depth of field, the field of view, and the transmittable intensity. What is by now needed in modern devices, such as smartphones, laptops and the like, are non-mechanical micro irides that have a very small installation volume and additionally have a low electrical operating voltage and a low power consumption with respect to the actuator systems. Such irides may be realized on the basis of the electrochromic effect [1, 2, 3, 4].

An electrochromic iris is an electrochemical cell that is illustrated in its cross-section in FIG. 9a and in a top view in FIG. 9b. Such a cell consists of two opposing transparent conductive layers 1002 and 1004. The layers 1002 and/or 1004 may be formed as a TCO layer (TCO=transparent conductive oxide; transparent electrically conductive electrode). There is a nanoparticle layer (NPL) 1007 on one or both of the TCO layers, where TiO₂ or ATO (antimony-doped tin oxide) nanoparticles are often used for material-technical reasons. The electrochromic molecule, e.g. viologen derivatives, is bound to the surface of the nanoparticles. Nanoparticles are used to massively increase the useable surface for binding the electrochromic molecules. An electrolyte 1006 is located between the electrodes 1002 and 1004. As soon as a potential difference U is applied between the two electrodes 1002 and 1004, depending on the magnitude/sign of the potential difference, the electrochromic molecules react by colorization or decolorization.

FIG. 9b shows a transparent state illustrating the separately controllable regions 1002a and 1002b.

Up to now, in order to realize the electrochromic iris with several aperture stops, i.e. the regions 1002a and 1002b, the TCO layer 1002 and the nanoparticle layer 1007 had to be structured such that coaxial ring-shaped electrodes that are individually drivable from the outside are created, cf. the regions 1002a and 1002b in FIG. 9b. Thus, each ring may be individually switched on or off, or may be individually, i.e. in an analog manner, adjusted with respect to its absorption.

However, it is difficult to structure the nanoparticle layer on a scale of few tens of micrometers so as to be able to define the iris aperture stops. Since a catalytic effect occurs with TiO₂ nanoparticles when ultraviolet (UV) light is additionally provided, organic compounds are decomposed in contact with the nanoparticles. Thus, the widely used UV lithography techniques for structuring with a UV-sensitive organic photoresist are completely eliminated. Microstructuring on a scale of a few micrometers is therefore not possible, since existing techniques such as doctoring or printing only enable creating structures on significantly larger spatial scales. Laser ablation also proves to be difficult, as ablation can damage the surface of the substrate and thus reduce its optical quality.

Gap-shaped openings that cannot be switched but are optically transparent are created between the ring-shaped aperture stops. This is illustrated in FIG. 9b as regions 1008. FIGS. 10a to 10d show photographs of various switching states of a three-stop iris according to the conventional technology, with the gap 1008 standing out clearly in FIG. 10c. Such gaps are detrimental to the optical effect of the iris, e.g. when controlling the depth of field, which should be adjustable via the aperture size.

### SUMMARY

An embodiment may have an apparatus for regionally changing an optical property, having: a counterelectrode; a working electrode having a structuring into at least a first electrode region and a second electrode region, wherein an intermediate region is arranged between the first electrode region and the second electrode region; an active material arranged between the counterelectrode and the working electrode and configured to change the optical property on the basis of an electrical potential difference between the counterelectrode and the working electrode; wherein the active material forms a continuous layer that covers at least a sub-region of the first electrode region and a sub-region of the second electrode region and is arranged in the intermediate region.

Another embodiment may have a system, having: an apparatus according to the invention; and a drive unit configured to apply simultaneously a reference potential to the counterelectrode, to apply a first—with respect to the reference potential—potential to the first electrode region, and to apply a second—with respect to the reference potential—potential to the second electrode region.

Another embodiment may have a method for providing an apparatus for regionally changing an optical property, the method having the steps of: arranging an active material between a counterelectrode and a working electrode, having a structuring into at least a first electrode region and a second electrode region, so that an intermediate region is arranged between the first electrode region and the second electrode region, so that the active material is arranged between the counterelectrode and the working electrode, so that the active material is configured to change the optical property on the basis of the electrical potential differences between the counterelectrode and the working electrode; so that the active material forms a continuous layer that covers at least a sub-region of the first electrode region and a sub-region of the second electrode region and is arranged in the intermediate region.

The inventors have realized that, by introducing an active material into regions between structured sub-regions of the structured electrode and through the potential drop that occurs there during operation, separately driving the individual partial regions/segments is possible, however, the formation of the optically interfering gaps may be avoided with the identical drive, thus obtaining a high quality of the apparatus. This enables avoiding gaps between the individual regions, or providing apparatuses that are spatially fully switchable.

According to an embodiment, an apparatus for regionally changing an optical property includes a counterelectrode and a working electrode. The working electrode comprises a structuring into at least a first electrode region and a second electrode region, wherein an intermediate region is arranged between the first electrode region and the second electrode region. The apparatus includes an active material arranged between the counterelectrode and the working electrode and configured to change the optical property on the basis of an electrical potential difference between the counterelectrode and the working electrode. The active material forms a continuous layer that covers at least a sub-region of the first electrode region and a sub-region of the second electrode region and is arranged in the intermediate region. Arranging the active material in the intermediate region enables obtaining and/or adjusting the variable optical property also in the intermediate region and therefore avoiding the optically interfering gap, thus obtaining a high optical quality.

According to an embodiment, the active material is continuously arranged with a variable material thickness across the first electrode region, the intermediate region, and the second electrode region. This enables a simple arrangement of the active material.

According to an embodiment, the active material comprises in the intermediate region a greater material thickness than in the first and second electrode regions. This enables a simple arrangement of a possibly viscose material from which the active material is obtained so that the active material may fill gaps between the electrode sub-regions.

According to an embodiment, the active material includes nanoparticles (with possibly electrochromic properties) and a multitude of electrochromic molecules that adhere to the nanoparticles. This enables obtaining a high degree of absorption since a large number of electrochromic molecules may adhere to the surface configured by the nanoparticles.

According to an embodiment, the apparatus includes an electrolyte arranged between the active material on the working electrode and the counterelectrode. The electrolyte may be in contact with the active material and may provide electrical contact between at least one of the electrodes and the active material.

According to an embodiment, the active material is electrically conductive. The material is configured to, upon a first potential difference (electrical voltage) between the first electrode region of the working electrode and the counterelectrode and a second potential difference between the second electrode region of the working electrode and the counterelectrode, configure a transition region in which the optical property switches from a first optical state, e.g. a first absorption state, into a second optical state, e.g. a second absorption state. That is, the change of state, absorbing/transparent or transparent/absorbing and/or with respect to a phase change or light emission, takes place within the active material. This enables a continuous transition between the optical states across a distance from the first electrode region to the second electrode region.

According to an embodiment, the active material is configured to, upon an identical first electrical potential difference between the first electrode region and the counterelectrode, on the one hand, and between the second electrode region and the counterelectrode, on the other hand, comprise a homogeneous first optical property across the first sub-region, the intermediate region, and the second sub-region. Upon an identical second electrical potential difference between the first electrode region and the counterelectrode, on the one hand, and between the second electrode region and the counterelectrode, on the other hand, the active material comprises a homogeneous second optical property across the first sub-region, the intermediate region, and the second sub-region. Thus, the active material may be simultaneously switched in the intermediate region, the first electrode region, and the second electrode region, thereby avoiding the occurrence of the optically interfering gap.

According to an embodiment, the working electrode and/or the counterelectrode is configured such that it is formed to be transparently electrically conductive. This enables obtaining an apparatus that is transparent at least in an optical state.

According to an embodiment, the counterelectrode is unstructured. This enables a simple configuration of the apparatus, since a step of structuring the counterelectrode may be omitted. Alternatively, a structured counterelectrode enables great flexibility of the spatial control.

According to an embodiment, the working electrode is configured such that it comprises a multitude of sub-regions that are spaced apart by a plurality of intermediate regions. This enables obtaining an apparatus with complex optical patterns that may be switched.

According to an embodiment, the apparatus is formed as an electrochromic iris. This enables the use in versatile optical applications, e.g. in cameras, in particular miniaturized cameras that may be employed, e.g., in a smartphone, laptop, optical measuring apparatuses or imaging devices such as endoscopes, microscopes, binoculars (here also as switchable sights), telescopes or the like. For example, the applications are in medical technology (endoscopy) and other handheld systems (smart glasses, etc.).

According to an embodiment, the second sub-region encloses the first sub-region. This enables obtaining a variable aperture.

According to an embodiment, the working electrode is structured into a multitude of electrode regions including the first electrode region and the second electrode region, the apparatus being formed as a pixel structure with a multitude of pixels, where each pixel includes an electrode region of the multitude of electrode regions. Configuring the apparatus as a pixel structure enables obtaining a display apparatus, e.g. a display, in which gaps between individual pixels may be avoided so that the optical display may be carried out with a high quality.

According to an embodiment, the working electrode is structured into a multitude of electrode regions including the first electrode region and the second electrode region, the apparatus being formed as a bar structure with a multitude of bars. Each bar includes an electrode region of the multitude of electrode regions. In particular, such an apparatus may be drivable as a target (reference pattern) of a spatial calibration standard. This enables obtaining a universal and simultaneously high-quality calibration target.

According to an embodiment, the apparatus is formed as an adjustable calibration target. This enables imaging different spatial frequencies in temporal alternation and therefore in a compact manner.

According to an embodiment, the active material is configured to provide a light emission, thus enabling high functionality.

According to an embodiment, the active material is configured to influence the phase of a passing electromagnetic wave, thus enabling high functionality.

According to an embodiment, the counterelectrode and/or the working electrode is configured to be reflective. This enables a reflective apparatus.

According to an embodiment, a system includes an inventive apparatus and a drive unit configured to apply simultaneously a reference potential (ϕ₀) to the counterelectrode, to apply a first—with respect to the reference potential—potential to the first electrode region, and to apply a second—with respect to the reference potential—potential to the second electrode region. This enables the transition between the first optical state in the first electrode region and the second optical state in the second electrode region in a comparably small lateral region of the active material.

According to an embodiment, the drive unit is configured to apply the first potential and the second potential such that a transition between a first optical state in a region of the first electrode region and a second optical state in a region of the second electrode region is carried out in a transition region with a dimension of up to 5 μm±50%. This enables obtaining the transition in a region that is still perceived as a sharp edge by the human eye. Even though there may be a continuous transition between the two states, this is still perceived by the observer as a sharp transition, which also offers advantages for the use in optical apparatuses with imaging qualities influenced by obtaining a sharp edge.

According to an embodiment, the driving unit is configured to apply the first potential (ϕ₁) and the second potential (ϕ₂) such that a potential difference in the range of a redox potential of the active material is obtained.

According to an embodiment, the system is formed as an apodization filter. Thus, such embodiments enable apodization filters with a complex radial absorption course, e.g. if, starting from a center point, individual rings, or groups of rings, are switched and at least individual rings are not switched.

According to an embodiment, the drive unit is configured to operate the apparatus as a gradient filter, thus enabling high quality radiant filters.

An embodiment creates a method for providing an apparatus for regionally changing an optical property. The method comprises arranging a counterelectrode and arranging an active material such that the active material is configured to change the optical property on the basis of an electrical voltage between the counterelectrode and the working electrode. The method includes arranging a working electrode comprising a structuring into at least a first electrode region and a second electrode region so that an intermediate region in which the active material is located is arranged between the first electrode region and the second electrode region. The active material forms a continuous layer that covers at least a sub-region of the first electrode region and a sub-region of the second electrode region, and is arranged in the intermediate region.

According to an embodiment, arranging the active material is carried out by means of a printing method. What is advantageous is that the printing method is a simple and cost-efficient arrangement possibility, and that disadvantages of such methods, e.g. with respect to imprecise region boundaries, are avoided at the same time since the active material is arranged as a continuous or coherent layer.

### BRIEF DESCRIPTION OF THE DRAWINGS

Embodiments of the present invention will be detailed subsequently referring to the appended drawings, in which:

FIG. 1a shows a schematic sectional side view of an apparatus according to an embodiment;

FIG. 1b shows a schematic top view of a structured electrode of FIG. 1a, comprising electrode regions;

FIG. 2a shows a schematic sectional side view of an apparatus according to an embodiment, wherein the active material is arranged with a variable thickness and in a gap between electrode regions;

FIG. 2b shows a schematic sectional side view of an apparatus according to an embodiment, wherein the active material is arranged with a variable thickness in a region of the electrode regions;

FIG. 3a shows a schematic sectional side view of an apparatus according to an embodiment, wherein an electrolyte may be arranged between the active material and an electrode;

FIG. 3b shows a schematic top view of a part of the apparatus of FIG. 3a so as to illustrate the electrode regions of the structured electrode;

FIG. 3c shows a schematic top view of an apparatus according to an embodiment, wherein the leads to the sub-regions of the working electrode are buried in a plane below the active material so as to be mutually electrically insulated;

FIG. 3d shows a schematic sectional side view of the apparatus of FIG. 3c;

FIG. 3e shows a schematic sectional side view of an apparatus according to an embodiment, wherein the counterelectrode is additionally structured;

FIG. 4a shows a schematic top view of an exemplary alternative configuration of the structured electrode according to an embodiment, with three or more mutually enclosing electrode regions;

FIG. 4b shows a schematic top view of a further alternative configuration of the structured electrode according to an embodiment, wherein the electrode regions comprise a triangular shape;

FIG. 4c shows a schematic top view of an apparatus according to the conventional technology, wherein sub-regions that form pixel elements are arranged;

FIG. 4d shows an apparatus with the electrode configuration according to FIG. 4c, configured according to an embodiment;

FIG. 4e shows a schematic top view of the electrode configuration according to FIG. 4d, operated as a gradient filter according to an embodiment;

FIG. 4f shows a schematic top view of a configuration of the working electrode, e.g. divided into two concentric circles exemplarily having 12 circle segments each, according to an embodiment;

FIGS. 5a-f show schematic top views of an apparatus according to an embodiment, formed as an electrochromic iris with three electrode regions that are individually drivable and are illustrated in different switching states of the electrode region;

FIGS. 6a-e show schematic top views of an apparatus according to an embodiment, wherein the structured electrode is formed as a bar structure with a multitude of bar in different switching states;

FIGS. 7a-c show schematic graphs of potential progressions according to an embodiment;

FIG. 7d shows a schematic sectional side view of an apparatus so as to illustrate FIGS. 7a-c according to an embodiment;

FIGS. 7e-g show schematic graphs of a possible variation of an optical property across the applied potential according to an embodiment;

FIG. 8 shows a schematic block circuit diagram of a system according to an embodiment;

FIG. 9a shows a cross-section of an electrochemical cell according to the conventional technology;

FIG. 9b shows a top view of the electrochemical cell according to FIG. 9a; and

FIGS. 10a-d show photographs of different switching states of a three-stop iris according to the conventional technology.

### DETAILED DESCRIPTION OF THE INVENTION

Before embodiments of the present invention are subsequently described in detail on the basis of the drawings, it is to be noted that identical or functionally identical elements, objects and/or structures or elements, objects and/or structures having the same effect are provided in the different figures with the same reference numerals so that the description of these elements illustrated in different embodiments is mutually exchangeable, or may mutually applicable.

The following discussion refers to apparatuses for regionally changing an absorption property. In particular, such apparatuses are micro-irides. However, embodiments are not limited thereto, but, to the same extent, also refer to other absorption structures, emission structures and/or transmission structures, e.g. optical filters, also including non-visible wavelength ranges such as ultraviolet or infrared, gradient filters, pixel structures with individually switchable pixels (image elements), bar structures and/or freely defined electrodes.

The active material is controllable by applying an electrical field. This may be used to control the complex-valued refractive index of the active material, which is composed of a real part and an imaginary part and, depending on the embodiment, may be direction-independent or direction-dependent. In the case of direction-dependence, the real part and the imaginary part may be illustrated as tensors. This results in the possibility to control the absorption and/or the real refractive index (with the effect of a phase shift on a transmitted wave) and/or the spatial change of all mentioned quantities. Thus, embodiments of the present invention are not limited to the change of an absorption property, but also refer to the change of other optical properties such as a local phase shift that an active material causes at transmitted light or other electromagnetic radiation, and/or to a light emission property. Changing the optical property may be carried out continuously or discontinuously, e.g. binary in the sense of “on/off” or in a multi-level manner.

To this end, embodiments of the present invention include electrodes, in particular a counterelectrode and a working electrode. At least one of these electrodes is structured into at least a first electrode region and a second electrode region. That is, electrical potentials may be independently applied to the first electrode region and the second electrode region. This includes the possibility of applying an identical potential (identical potential value), however, in particular, it is possible to apply different potentials to the different electrode regions. Advantageously, the electrodes are formed from transparent conductive materials, in particular, from transparent electrically conductive oxides (TCO). Examples for such TCOs are indium tin oxide (ITO), fluorine tin oxide (FTO), aluminum zinc oxide (AZO), cerium oxide (CeO) and/or antimony tin oxide (ATO). Other materials and/or combinations thereof are also possible, e.g. graphene. In another embodiment, one of the electrodes may be configured as a reflective electrode.

The counterelectrode and the working electrode may be arranged opposite each other so that a corresponding electrical field and/or charge carrier current may be formed between the respective electrode region and the opposite electrode. Optionally, the other electrode also comprises a structuring. This may be configured to be identical to the structuring of the structured electrode.

Embodiments further refer to the arrangement of an active material. In particular, reference is made to an optically active material that changes an optical property, or an absorption property, a transmission property and/or an emission property, upon the application of an electrical voltage. For example, an optical property or absorption property is a colorization and/or an at least partial switch between being absorbing and transparent, or being transparent and absorbing. Both are summarized by the term absorption property in the context of the embodiments explained herein. A variable absorption and/or transmission may result in a colorization and/or a variable transparency of the active material. In other words, a colorization of the active material may be understood to be a binary or analog/continuous switch between being transparent and absorbing. The active material may comprise electrochromic molecules such as viologen derivatives. In addition, the active material may comprise nanoparticles to which the electrochromic molecules are bound. In embodiments, the electrochromic molecules adhere to the nanoparticles. Alternatively or additionally, the nanoparticles themselves may comprise electrochromic properties.

Examples for such nanoparticles are TiO₂ nanoparticles. Alternatively or additionally, the active material may also be a combination of electrochromic nanoparticles, i.e. nanoparticles with electrochromic properties, and electrochromic molecules adhered thereto, or bound thereto.

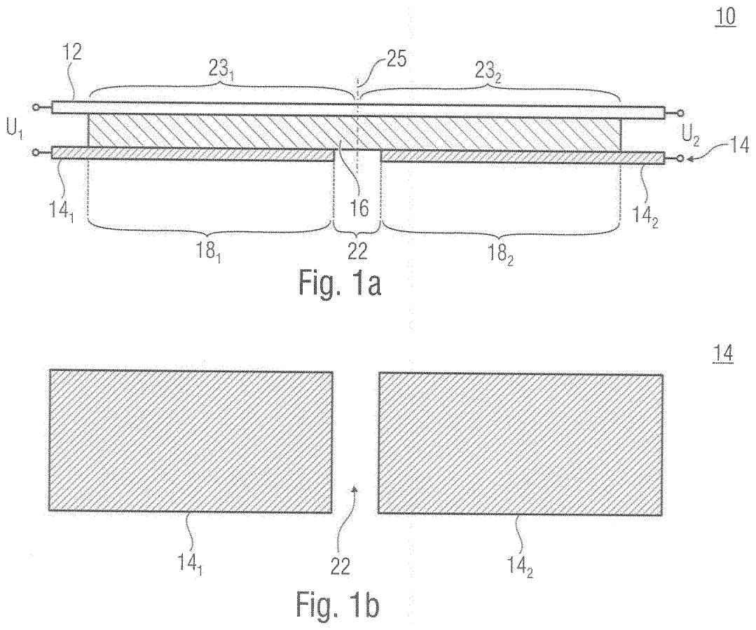

FIG. 1a shows a schematic sectional side view of an apparatus 10 according to an embodiment. The apparatus 10 includes a first electrode 12 and a second electrode 14 arranged opposite thereto. For further explanation, the first electrode 12 may be referred to as the counterelectrode, while the second electrode 14 may be referred to as the working electrode, e.g., to which a variable electrical potential may be applied, whereas the counterelectrode may provide a reference potential, or counter potential, (ϕ₀) for the working electrode, which may or may not necessarily remain unchanged. At least the electrode 14 is structured into a first electrode region 14₁ and a second electrode region 14₂.

At least one of the electrodes 12 and/or 14 as well as possible additional substrate layers may be formed so as to be transparent, e.g. by arranging a TCO layer, i.e. the electrode 12 and/or 14 may include a TCO layer or consist thereof. If the second electrode is also transparent, the component may be used in transmission. Alternatively, e.g., the further electrode may be formed to be reflective, e.g. by arranging a reflective layer, so that the component may be used in reflection.

The electrode regions 14₁ and 14₂ may be galvanically separated from one another so that different electrical potentials may be applied to the electrode regions 14₁ and 14₂. In this way, an electrical voltage U₁ may be applied between the electrode region 14₁ and the electrode 12, and a voltage U₂ may be applied between the electrode region 14₂ and the electrode 12. Even though the electrode 12 is illustrated as an unstructured electrode, the electrode 12 may be structured into at least two electrode regions, i.e. the embodiments described herein are not limited to an unstructured electrode 12.

In electrochemistry, the term reference electrode is used as a fixed expression for a precisely defined potential against which the potential of a working electrode is varied or adjusted, often assuming that the reference electrode does not draw an electrical current. Through the potential of the reference electrode, a corresponding current is created towards the counterelectrode; the potential of the counterelectrode is adapted thereto. Thus, a three-electrode arrangement is used. In other words, embodiments do not use a reference electrode in the sense of electrochemistry, since exact knowledge about the potentials is not necessarily required. The individual components may work analogously even when not using a reference electrode.

An active material 16 is arranged between the electrode 12 and the electrode 14. The active material 16 is configured to, upon different electrical potentials to which it is exposed, comprise different, or variable, optical properties, such as being transparent/colored, different absorption levels and/or different colors, i.e. different absorption properties. Alternatively or additionally, at least one other optical property may be changed, e.g. a phase shift caused by the variation of the real refractive index of the active material and/or a light emission provided. For example, the active material 16 may include a nanoparticle layer (NPL) and/or an electrochromic/light emitting material, it being possible to bind at least one electrochromic/light emitting molecule to the nanomaterial and to arrange the electrochromic/light emitting material directly. The active material 16 at least partially covers the electrode region 14₁ and at least partially covers the electrode region 14₂ in the surface regions 18₁ and 18₂. That is, the surface regions 18ᵢ describe surface regions of the electrode regions 14₁ that are covered by the active material 16. According to an embodiment, the active material 16 is arranged such that it fully covers the electrodes 14 and/or 12; however, embodiments are not limited thereto. That is, a region in which the material 16 is omitted or not arranged, e.g. so as to arrange a hermetic seal there, may be arranged at the edges of the electrodes 12 and/or 14. In addition, the active material 16 is arranged in an intermediate region 22. The intermediate region 22 may be understood as an intermediate space or distance between the electrode regions 14₁ and 14₂. For example, the intermediate region 22 may be generated by the structuring of the electrode 14.

The active material may be influenced by the electrical voltages U₁ and/or U₂, such that respective portions or sub-regions 23₁ and/or 23₂ of the active material that are under the influence of the electrical voltages U₁ and/or U₂ are influenced or varied with respect to the absorption property. Although the surface area of the sub-regions 23₁ and/or 23₂ is influenced by the dimension and the location of the electrode regions 14₁ and 14₂, it exceeds them. That is, starting from a region between the electrode region 14₁ and the first electrode 12, the sub-region 23₁ extends into the intermediate region 22, or into a region between the intermediate region 22 and the first electrode. Starting from a region between the electrode region 14₂ and the first electrode 12, the sub-region 23₂ also extends into the intermediate region 22, or into a region between the intermediate region 22 and the first electrode. The active material 16 arranged between the intermediate region may be switched from the respectively adjacent electrode region 14₁ or 14₂, wherein a boundary 25 between the sub-regions 23₁ and 23₂ may be variable or constant on the basis of the variable voltages U₁ and/or U₂.

In combination with further optical properties, a functional integration of the apparatus 10 may be obtained. Thus, according to embodiments, the electrodes 12 and 14 are configured to be transparent at least in an application-dependent continuous or distributed wavelength range, e.g. the visible wavelength range, the infrared wavelength range, the ultraviolet wavelength range, and/or other wavelength ranges. In a state of low or partial absorption by the active material 16, the apparatus 10 may be formed to be at least partially transparent.

According to embodiments, at least one of the electrodes is configured to be reflective into a direction towards the active material 16. In the state of a low or partial absorption by the active material 16, the apparatus 10 may be formed to be at least partially reflective, e.g. so as to implement a spatially absorbing mirror.

According to embodiments, what is provided is a combination of a transparent configuration with a reflecting configuration. Thus, the apparatus 10 may comprise a reflecting layer, e.g. formed by the electrode 12 or 14. The active material 16 may be used to control regions that are not to, or partially, reflect. To this end, compared to other embodiments, one of the transparent electrodes may be replaced by a metal layer as a mirror, or alternatively by a dielectric mirror that is coated with a conductive, possibly also transparent, layer.

A further functional integration is possible by the configuration of at least one of the electrodes 12 and/or 14 as a reflective electrochromic aperture that is controllable in a transparent state as well. The electrode 12 and/or 14 may therefore be formed so as to be reflective in an active and/or passive state.

By electrically switching the absorption property, the strength of the absorption may be adjusted in an analog manner. Indirectly, this also enables to adjust the transmission, or reflection, of the apparatus. For transmitting components, adjusting the absorption may mean that they are only partially transparent in the switched state, for example. For reflecting components, adjusting the absorption may mean that they reflect light in the non-switched region in the non-switched state, for example, and that the light is partially absorbed in the other regions. According to embodiments, partially may mean that the absorption may be switched on only partially.

Even though the active material 16 does not have to provide light emissions, it is within the scope of the embodiments to provide one or several luminescent active materials used to this end. The active material 16 may be configured to provide a light emission. This may be done by suitably configuring the active material 16 as a reaction to an electrical signal, on the basis of electroluminescence and/or on the basis of fluorescence.

On the basis of the continuous layer of the active material 16, a distance between the sub-regions 23₁ and 23₂ may be small or even absent in both sub-regions 23₁ and 23₂ in the event that the active material 16 is activated, or it may configured so that it is imperceptible to an observer.

FIG. 1b shows a schematic top view of the electrode 14 comprising the electrode regions 14₁ and 14₂.

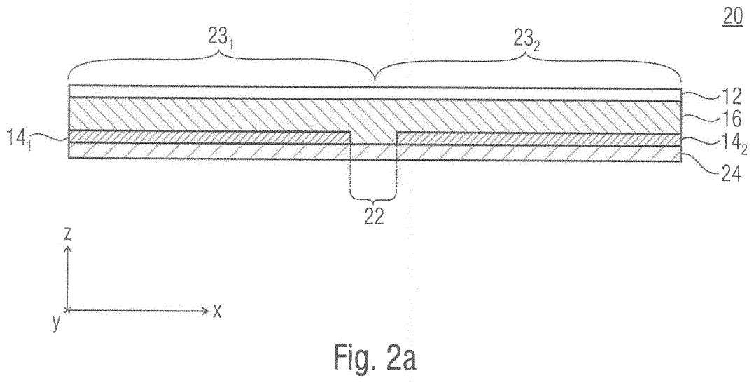

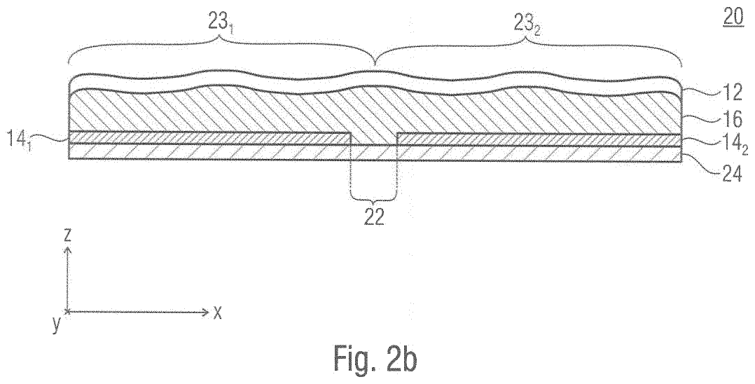

FIG. 2a shows a schematic sectional side view of an apparatus 20 according to an embodiment. Compared to the apparatus 10, the active material 16 is not just arranged at the main side of the electrode regions 14₁ and 14₂ facing the electrode 12, but it also covers the secondary sides that define the intermediate region 22. The active material 16 may have a variable material thickness along a lateral direction, e.g. the x-direction, which extends starting from the electrode region 14₁ across the intermediate region 22 towards the electrode region 14₂. A material thickness may be understood as a layer thickness of the layer of the active material 16 along a direction perpendicular to the lateral direction x, e.g. a direction starting from the electrode 14 towards the electrode 12, e.g. the z-direction. That is, the active material 16 may have a variable material thickness across the x-direction if the material thickness in the electrode regions 14₁ and 14₂ is compared to the material thickness in the intermediate region 22. For example, a layer thickness in the intermediate region may be larger by a material thickness of the electrode 14, e.g., in a range of approximately 10 nm, 50 nm, or 100 nm, but also by any other value. In the electrode regions 14₁ and/or 14₂, the material thickness may have a value that is larger than the value of the electrode at least by one order of magnitude, e.g. at least 1000 nm or at least 3000 nm, approximately 3500 nm or more, approximately 10 μm.

The active material 16 may also be arranged in the intermediate region 22 such that it fills a gap created by the structuring. In particular, this enables the use of printing methods for arranging the active material 16 during manufacturing of the apparatus 20.

The apparatus 20 may comprise a substrate 24 that is advantageously transparent. To this end, transparent polymers or oxides may be used, alternatively or additionally, a glass material may be used. During manufacturing, the substrate 24 may support or simplify the arrangement of further components. If the substrate 24 is used during manufacturing only, it may also be formed so as to be at least partially opaque and may be removed after manufacturing, for example.

FIG. 2b shows a schematic sectional side view of an apparatus according to an embodiment, wherein the active material is arranged with a variable thickness in a region of the electrode regions, e.g. in the region 23₁ and/or 23₂. The electrode 12 may have a constant layer thickness and, e.g., may be uneven on a side facing away from the active material 16, but may alternatively also have a variable layer thickness, e.g. so as to at least partially compensate the layer thickness variation.

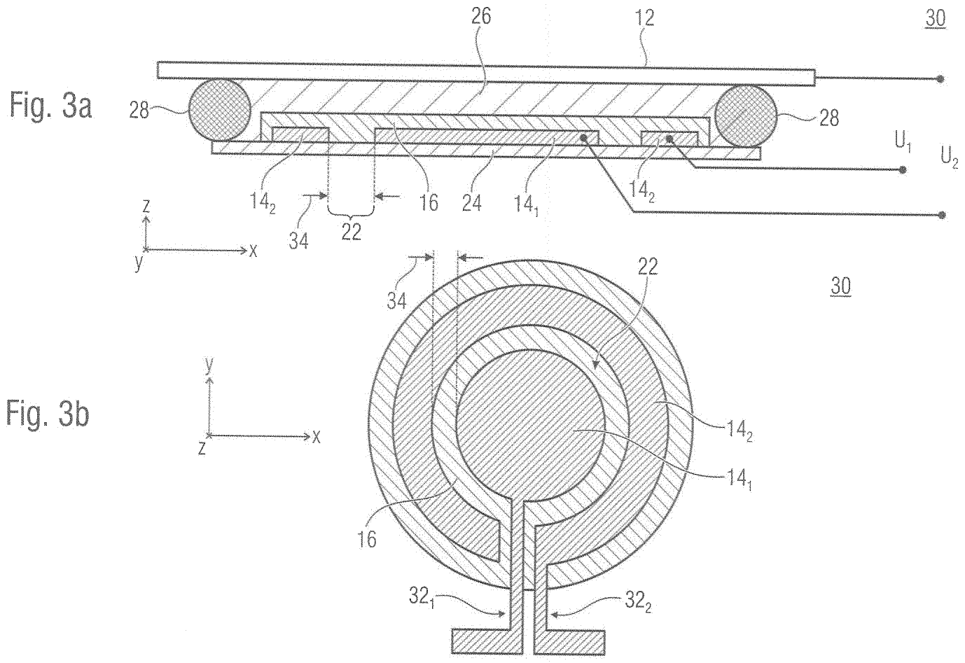

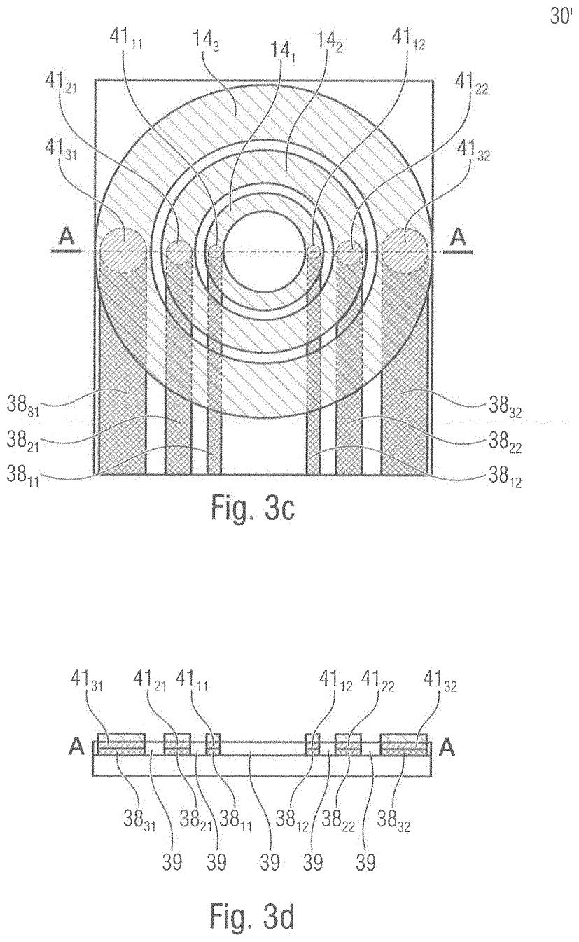

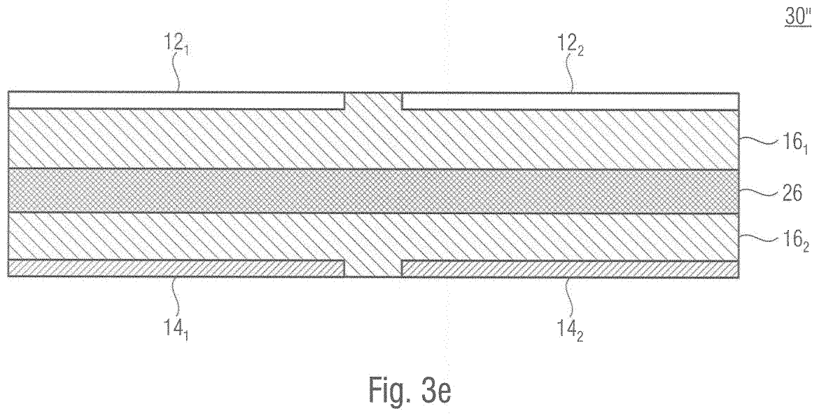

FIG. 3a shows a schematic sectional side view of an apparatus 30 according to an embodiment, where an electrolyte 26 may be arranged between the active material 16 and the electrode 12. One or several known electrolytes, e.g. LiClO₄ in propylene carbonate, may be used as the electrolyte.

A seal 28 may be arranged between the electrode 12 and the substrate 24, alternatively between the electrode 12 and the active material 16, i.e. a material or a body that prevents escape of the electrolyte 26 and/or ingress of oxygen and water. The seal 28 is advantageously formed as a hermetic seal. Alternatively, the seal may also be carried out by bonding and adhesive processes.

The electrolyte may be configured to provide an electrical connection between the electrode 12 and the active material 16, or the electrode 14, on the basis of an electrical conductivity, i.e. to enable a charge exchange. An electrical short circuit between the electrode 12 and the electrode region 14₂ is prevented, however. Even though the apparatus 30 is illustrated such that the electrolyte 26 is arranged between the active material 16 and the electrode 12, the electrolyte 26 may also be arranged between the active material 16 and the electrode 14.

FIG. 3b shows a schematic top view of a part of the apparatus 30 so as to illustrate the electrode regions 14₁ and 14₂. The active material 16 exemplarily comprises an overhang or overlap with respect to the electrode regions 14₁ and 14₂, i.e. the active material is arranged on the full surface of the electrode regions 14₁ and 14₂, with outer contact regions 32₁ and 32₂ possibly being excluded therefrom. In addition, the active material 16 is also arranged in the intermediate region 22 between the electrode regions 14₁ and 14₂, and, starting from the electrode region 14₁, comprises an overhang beyond the electrode region 14₂ in the radial direction.

The electrode region 14₂ encloses the electrode region 14₁. On the basis of the individual drivability of the electrode regions 14₁ and 14₂, different switching states of the apparatus 30 may therefore be obtained, i.e.:
a) an inactive state in the electrode regions 14₁ and 14₂;
b) an active state in the electrode region 14₁ and an inactive state in the electrode region 14₂;
c) an inactive state in the electrode region 14₁ and an active state in the electrode region 14₂; and
d) an active state in the electrode regions 14₁ and 14₂.

On the basis of the geometry of the electrode regions 14₁ and 14₂, the apparatus 30 may also be referred to as electrochromic iris.

With the exception of openings or ridges used for the electrical connection of the electrode regions 14₁ and 14₂ to the contact regions 32₁ and 32₂, respectively, the electrode region 14₂ may fully enclose the electrode region 14₁. In addition, additional electrode regions may be arranged, e.g., which enclose the electrode region 14₂ and/or are enclosed by the electrode region 14₁. A corresponding intermediate region respectively providing a distance between the electrode regions may be arranged between each of the electrode regions.

The intermediate region 22 may have a dimension 34, e.g. along the x-direction or any other direction such as a radial direction, that follows an optical design rule. The dimension may have any value, e.g. a value of up to 10 mm, up to 5 mm, up to 1 mm, up to 100 μm, up to 80 μm, or up to 50 μm. A maximum value of the dimension 34 may be influenced by the that fact in which region around an electrode region 14₁ and/or 14₂ the absorption property of the active material 16 may be adjusted with the maximum admissible or determined electrical voltages, in particular such that, when activating both electrode regions, the property of the active material in the intermediate region 22 is adjusted homogenously.

FIG. 3a and FIG. 3b show a structuring of the stack in a plane of the stack layer (in-plane), e.g. by discontinuation of the sub-region 14₁, so that carrying out a lead to the sub-region 14₂ is made possible. FIG. 3c and FIG. 3b show an alternative design according to embodiments, building a layer stack in which the sub-regions 14₁, 14₂ and 14₃ are formed as continuous ring structures that may be applied with an electrical potential via at least one, as illustrated, two or possibly more control electrodes 38₁₁ and 38₁₂, 38₂₁ and 38₂₂, or 38₃₁ and 38₃₂. The working electrode may be buried in a plane below the active material. FIG. 3c shows a schematic top view of such an apparatus 30′, while FIG. 3d shows a schematic side-sectional view of the apparatus 30′. Leads to the sub-regions of the working electrode in a plane below the active material are mutually electrically insulated and buried.

For example, the control electrodes 38₁₁ to 38₃₂ may be formed of a TCO layer so as to enable a transparent state. In the case of a desired reflective state, the transparency of the control electrodes 38₁₁ to 38₃₂ may be possibly omitted.

The control electrodes 38₁₁ to 38₃₂ may be spaced apart and/or partially covered by an insulating layer 39. Advantageously, the insulating layer may be formed so as to be transparent, and may include, e.g., parylene, silicon nitride (SiN) and/or particularly advantageously silicone dioxide (SiO₂). The control electrode may be connected to the sub-regions 14₁ to 14₃ at transition regions 41₁₁ to 41₃₂ of the respective control electrode 38₁₁ to 38₃₂, e.g. by opening the insulating layer 39 in the transition regions 41₁₁ to 41₃₂, and generating the electrical contact to the continuous rings there. This may also be referred to as contacting by means of via-throughs.

FIG. 3e shows a schematic sectional side view of an apparatus 30″ according to an embodiment, on the basis of which further advantageous further implementations are described, which may implemented individually or in any combination and also in connection with other embodiments described herein. The counterelectrode 12 may be segmented into one or several electrode regions 12₁ and 12₂, where the segmentation may be done in the same way as for the electrode 14. Advantageously, the electrode regions 12ᵢ and 14ᵢ are implemented in the same number, i.e. in case of the electrode 12, the number of the electrode regions is not limited to two, but may be higher. In embodiments, when projected onto a mutual plane, both electrodes 12 and 14 are structured identically or at least geometrically similar with respect to the number of the electrode regions, the size of the electrode regions and/or the position of the electrode, within a tolerance range of 10%, 5%, or 2%, for example. Alternatively, the segmentation may also be different.

Alternatively or additionally, an active material may be arranged at both electrodes so that two (or more) layers 16₁ and 16₂ of active material are arranged. At least one layer of the electrolyte 26 may be arranged between the sheets 16₁ and 16₂. That is, the electrolyte may be arranged in one or several layers, or that layers consisting of the electrolyte or mainly comprising the same may be arranged. Thus, the electrolyte is not mixed with active material, as is applied in liquids of LCD (Liquid Crystal Displays). The layers 16₁ and 16₂ may include the same or a different active material. For example, while the use of an identical material in several layers enables a step-wise combinational adjustment of the optical state or the optical property, a combination of different active materials may enable a combination of properties. Thus, for example, the active materials may comprise spectrally different properties such as with respect to the colorization, filtered or influenced wavelengths or the like. For example, the active materials in the layers 16₁ and 16₂ may be of the same type, e.g. they may both be from the group of viologenes or triarylamines. Alternatively, a combination of different groups may be used. Embodiments according to the invention are not limited to the use of one or several layers of active materials. Further layers may be used, particularly when using transparent electrodes.

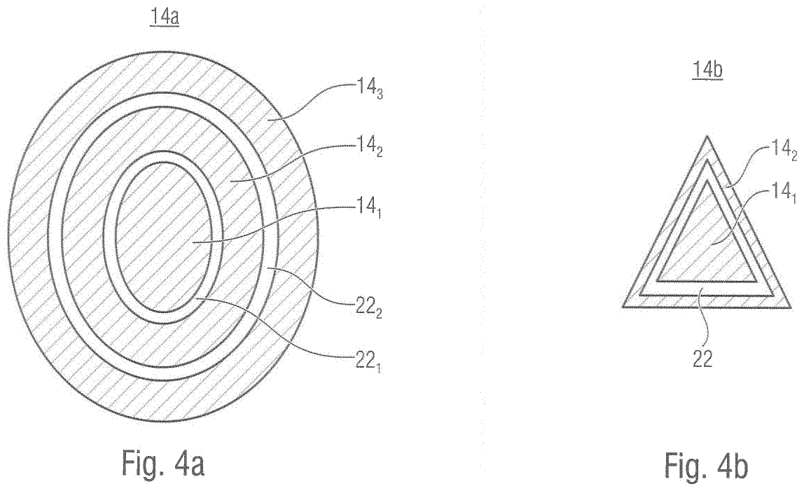

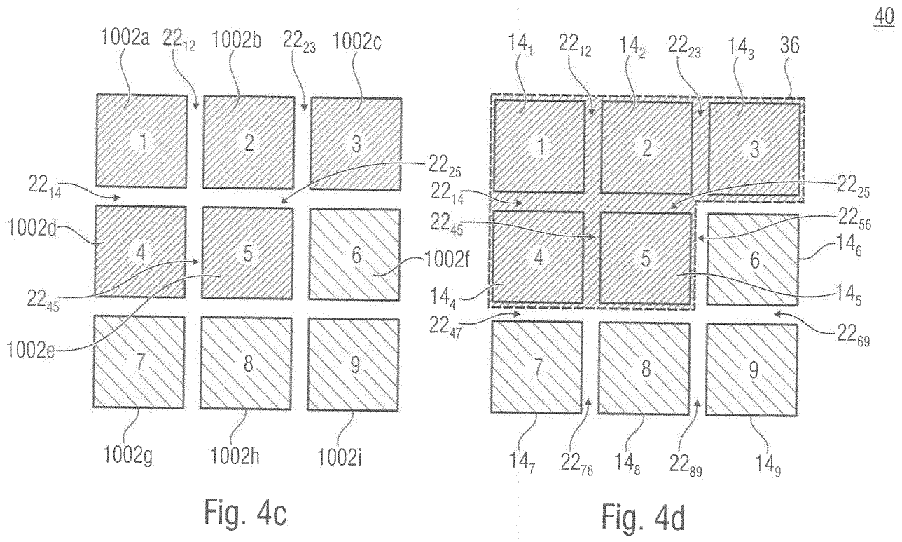

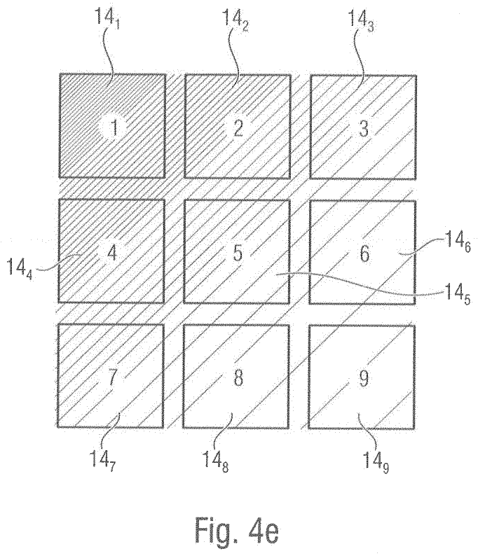

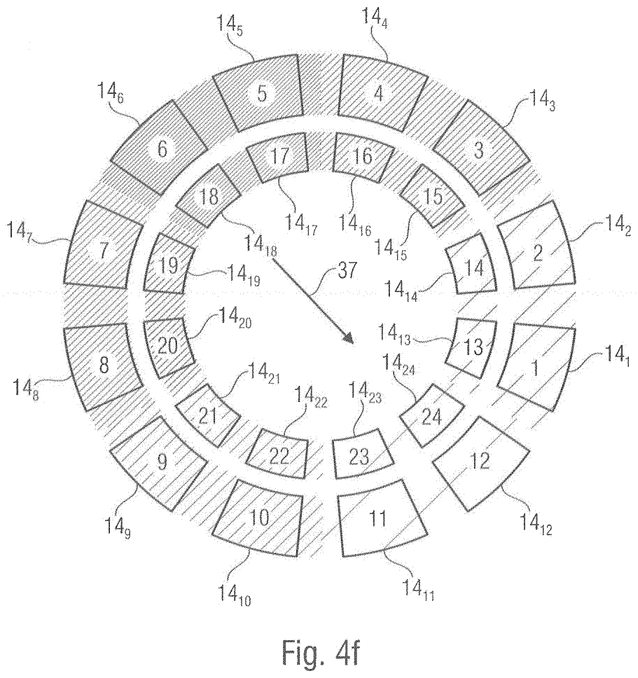

FIG. 4a shows a schematic top view of an exemplary alternative configuration 14a of the electrode 14, which is structured into three or more mutually enclosing electrode regions 14₁ to 14₃. The inner electrode region 14₁ may be configured as a planar oval, but may alternatively be formed as an oval ring structure, same as the sub-electrode regions 14₂ and/or 14₃. An intermediate region 22₁ and 22₂ is arranged between two adjacent sub-regions 14₁ and 14₂, and 14₂ and 14₃, respectively, which adjust an identical or individual distance between the sub-regions of the electrode 14. An oval structure enables the use of inclined beam splitting elements. For example, if the electrode 14 is inclined about a secondary axis, e.g. by 45°, an optically effective circle may result from the oval/ellipse due to a compression of the major axis in a beam direction, if this is desired.

FIG. 4b shows a schematic top view of a further alternative configuration 14b of the electrode 14, wherein the electrode regions 14₁ and 14₂ have a triangular shape.

However, the embodiments of the invention described herein are not limited to a round, oval, or triangular shape, nor do they depend on a uniform shape existing between the sub-regions of the electrode 14. According to further embodiments, a round, polygonal, or freeform surface of the sub-regions 14ᵢ may be selected. The sub-regions may enclose each other, but alternatively may be arranged to be laterally adjacent to each other. Possibly, the sub-regions may be connected by small connecting lines that are designed in such a way that a well-defined voltage drop takes place at them, so that the entire arrangement may be controlled with only one voltage.

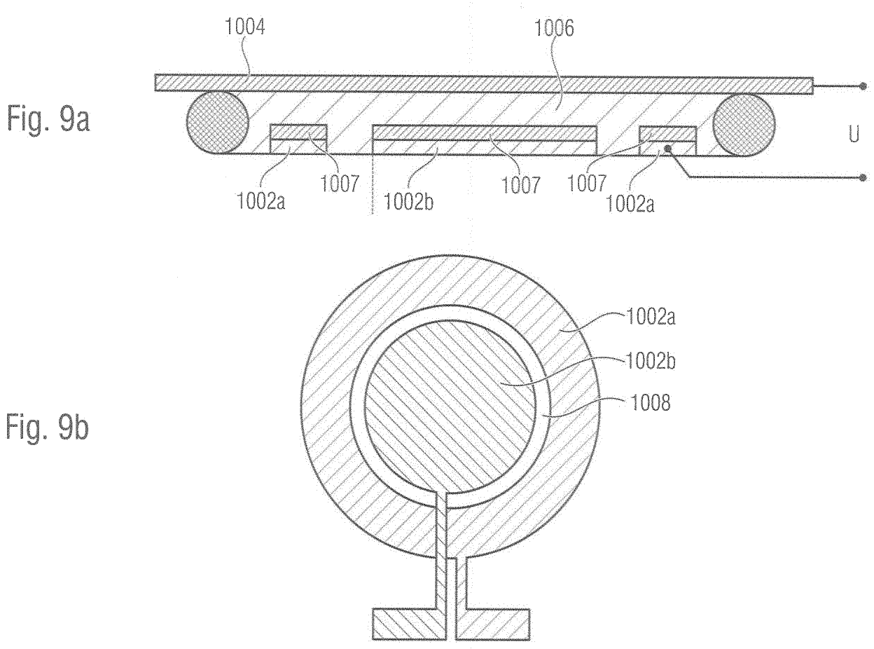

FIG. 4c shows a schematic top view of an apparatus according to the conventional technology, having arranged sub-regions 1002a to 1002i that form pixel elements and that are referred to with the numbers 1 to 9, which are formed in accordance with the configuration explained in connection with FIG. 9a. That is, each of the pixel elements is individually drivable and electrically insulated from adjacent elements. If the elements 1 to 5 are exemplarily driven, they absorb independently of each other, with gaps arising in intermediate spaces 22₁₄ to 22₄₅, respectively, without optical activation. Driven sub-regions are spaced apart from each other.

FIG. 4d shows, according to an embodiment, an apparatus 40 configured with the electrode configuration according to FIG. 4c, with the active material being arranged in the intermediate spaces 22₁₂ to 22₅₉ according to the discussions in connection with the embodiments described herein. This enables a reduction or avoidance of distances between the sub-regions so that a continuous absorption region 36 may be obtained, wherein an absorption region is understood to be a region in which the absorption property is controlled. These discussions are not limited to the absorbing of light.

When driving the electrode regions 14₁ to 14₅, the respective pixel elements including the intermediate regions, e.g. the intermediate regions 22₁₂, 22₂₃, 22₁₄, 22₂₅ and 22₄₅, located there between perform the absorption, i.e. the continuous absorption region 36 may be obtained. The absorption region 36 may extend beyond the respective sub-regions 14₄ and/or 14₅, towards adjacent, but non-activated, or differently driven sub-regions, such as the sub-regions 14₆ to 14₉, since the active material is also arranged in the intermediate regions arranged there, and there is a potential drop in the active material. The edge of the absorption region may be formed out of a combination of the respective boundary 25 of FIG. 1a, associated with the respective sub-regions 14₁ to 14₉, i.e. as a total surface. If one of the electrodes is implemented as a reflective layer, the component may be used in reflection. In case of a partially reflective electrode, a controllable beam splitter is therefore possible as well.

In other words, an application of the technique described herein is in the field of pixel-orientated reflective and/or transmitting displays (also referred to as spatial light modulators). For example, a 3×3 matrix of pixels, or the control electrodes, is illustrated, wherein the pixels 1 to 5 are switched herein. In the conventional case according to FIG. 4c, each pixel is surrounded by a transparent border due to the separate electrodes and the active material. According to FIG. 4d, the active material is continuous. Therefore, the electrochromic molecules are switched in the intermediate region as well. There are no more transparent gaps, but the area of the display may be completely switched between the electrodes.

Even though FIG. 4d is shown such that the sub-regions 14₁ to 14₅ are switched and the further sub-regions 14₆ to 14₉ are not switched, unlike in such a binary configuration, a continuous variation in the absorption property may also be set, as is described in more detail on the basis of FIG. 4e.

FIG. 4e shows a schematic top view of the electrode configuration according to FIG. 4d, e.g. operated as a gradient filter. For example, a first—possibly maximum—absorption may be generated in the sub-region 14₁. A first—possibly largest—electrical potential may be applied to the sub-region 14₁ for the first absorption. A second, lower potential may be applied to adjacent sub-regions 14₂ and 14₄ so as to obtain a lower absorption in the sub-regions 14₂ and 14₄. This may enable obtaining a continuous progression between the first level of absorption and the second level of absorption. A third level of absorption may be obtained in the sub-regions 14₃, 14₅ and 14₇, e.g. by applying a third potential in these sub-regions. A fourth potential, e.g. a minimum potential or a potential for deactivating the absorption property, may lead to transparency or reflection in the sub-region 14₉.

Considering a straight line between centroids of the sub-regions 14₁ and 14₉, a continuous transition of the absorption property may take place between two adjacent possibly discontinuous potentials. This enables the use of the apparatus as a gradient filter.

FIG. 4f shows a schematic top view of a configuration of the electrode 14, e.g. divided into two concentric circles each having 12 circle segments 14₁ to 14₁₂ and 14₁₃ to 14₂₄, respectively, wherein the sub-regions 14₁ to 14₂₄ may be driven individually. FIG. 4f shows an exemplary switching state of the electrodes so as to configure a gradient 37 between sub-regions 14₅, 14₆ and 14₇ of maximum absorption and sub-regions 14₁, 14₁₁ and 14₁₂ of minimum absorption, wherein a gradient progression of the absorption property along the gradient 37 may be obtained by accordingly driving the intermediate sub-regions. According to further embodiments, the sub-regions are arranged in a one or two ring pattern (e.g. 3, 4, 5, or more) that may be concentric. In order to obtain a high level of symmetry, the sub-regions may be geometrically similar in different rings or may comprise an identical area within a ring; however, this is not required. According to further embodiments, the electrode 14 is divided into arbitrary sub-regions.

In other words, FIG. 4d to FIG. 4f show illustrations of pixel components that may be operated as gradient filters according to embodiments. The absorption of each individual pixel (controlled by at least one sub-region) may be controlled in an analog manner. For example, if the voltage is reduced from pixel to pixel in at least one desired direction, e.g. along the gradient 37, what may be obtained is an optical gradient filter that used the inventive idea that an intermediate space between two adjacent pixels is also colorized due to the spatial gradients. When setting two or more desired directions, a complex gradient field may be set. Even though rectangular pixels are known and may be implemented, the pixels may be obtained through an additional segmentation of differently shaped electrodes, such as ring electrodes. This enables the combination of an iris and a gradient filter. FIG. 4f illustrates in a simplified manner the varying colorization across the pixel area. Even though the shading is illustrated such that it is variable across a sub-region 14—the colorization/absorption may be almost constant, when considered across each pixel/sub-region.

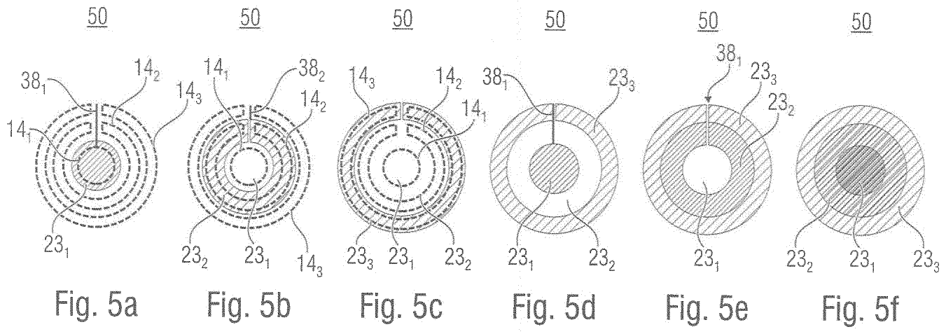

FIGS. 5a to 5f show schematic top views of an apparatus 50 according to an embodiment, formed as an electronic iris with three electrode regions 14₁ to 14₃ of the electrode 14, which are individually drivable. This results in three sub-regions 23₁ to 23₃ of the active material, in which the absorption property is controllable individually. In this case, a correspondingly configured sub-region 14₁ may form a round inner sub-region 23₁, e.g. enclosed by the electrode region 14₂ and a sub-region 23₂ controlled therewith. For example, the electrode region 14₂ is enclosed by the electrode region 14₃ so that the sub-region 23₃ also encloses the sub-region 23₂. For example, the electrode regions 14₂ and 14₃ are formed in a ring-shaped manner and are discontinued at locations at which leads 38₁ and 38₂ extend from an edge region towards the respective electrically supplied electrode region 14₁ and 14₂. That is, the electrode region 14₁ is connected to an electrically conductive element 38₁ that can be understood as a part of the electrode region. The electrode region 14₂ may also be electrically contacted via the lead 38₂. For example, contacting is possible through via-throughs, as is described in connection with FIGS. 3c and 3d, for example.

FIGS. 5a to 5f show different switching states, where only the inner sub-region 23₁ is switched in FIG. 5a, e.g. by activation, so that the active material absorbs light, or alternatively by deactivation of the active material.

FIG. 5b illustrates a switching state in which only the sub-region 23₂ absorbs.

FIG. 5c shows a schematic top view of the apparatus 50 in a state in which only the sub-region 23₃ absorbs.

FIG. 5d shows a schematic top view of the apparatus 50, where the sub-regions 23₁ and 23₃ perform absorption, while the intermediate electrode region 14₂ is inactive, e.g., so that the sub-region 23₂ is possibly transparent.

FIG. 5e shows a schematic top view of the apparatus 50, where the inner sub-region 23₁ is transparent, while the sub-regions 23₂ and 23₃ perform absorption. If the sub-region 23₁ is transparent, the active material covering the line 38₁ may also be transparent so that the line 38₁ may be recognized as a transparent strip. For example, such an influence may be at least partially alleviated by further implementation according to FIGS. 3c and 3d.

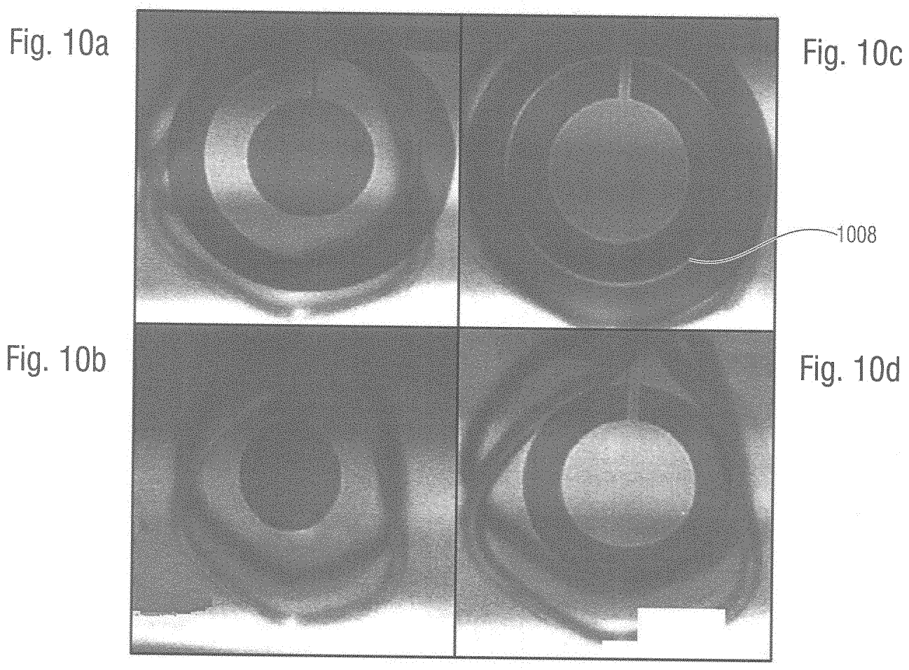

FIG. 5f shows a schematic top view of the apparatus 50 in a switching state in which sub-regions 23₁, 23₂ and 23₃ perform absorption. Similar to FIG. 5e, what becomes clear is that upon absorption of adjacent sub-regions 23, an occurrence of a transparent line in intermediate regions, e.g., as can be seen in FIG. 10c where no active material is arranged in the intermediate regions, is avoided. This is achieved by the fact that the active material may be applied homogenously and therefore in an unstructured manner. With respect to the apparatus 50, the inventive idea is implemented such that the TCO layers are structured such that they provide ring-shaped aperture stops; however, the active material is configured as a homogenous layer. This circumvents the technical structuring problems of the active material.

If an aperture stop is switched, a colorization may also occur in the region of adjacent non-switched apertures due to a diffusion of the charge carriers through the continuous layer of the active material. In order to reduce or avoid this, a potential may be additionally applied to the non-switched electrodes so that these layers remain transparent. If several apertures are connected in series, all electrodes act like an equipotential area, and the active material may be switched in the gap region as well, even though there is no TCO layer (electrode) underneath the layer of the active material.

In other words, FIGS. 5a to 5f show the technical implementation of the present invention in a three-stop iris. In the three images on the left (FIGS. 5a to 5c), only one iris stop is switched in each case, in the fourth image (FIG. 5d) stops 1 and 3 are switched, in the fifth image (FIG. 5e) stops 2 and 3 are switched without a transparent gap, and finally in the sixth image (FIG. 5f) all three stops are switched without a transparent gap. FIGS. 5a to 5f show a three-stop iris with all possible switching states. It should be emphasized that there is no transparent gap between the iris stops in FIGS. 5e and 5f. As a TCO layer, the active material may comprise TiO₂ nanoparticles with electrochromic viologen derivative molecules arranged on ITO. Alternatively or additionally, further materials may be arranged, e.g. antimony tin oxide (ATO) or cerium oxide (CeO), coated materials, e.g. coated ATO particles, or the like. Thus, embodiments according to the invention make it possible to avoid the structuring of the active layer. Since microstructuring of the active layer is not necessary, gap-shaped non-switchable regions between the aperture stops may be avoided. This makes it possible to avoid the elaborate structuring process of the active layer.

Thus, the embodiments according to the invention clearly stand out from known concepts. Particularly, with respect to U.S. Pat. No. 9,759,984 B1, where the electrical insulation has to be achieved between two regions of an electrode, an electrically conductive active material that permits a flow of charge carriers is used in the present case. This is the basis for the possibility to change the optical properties in the intermediate regions as well. That is, an apparatus as described herein may be configured to change the optical property in the intermediate region on the basis of the potential difference adjacent thereto. In particular, the apparatuses may be configured to change the optical property in the entire intermediate region, i.e. a total region, or across the entire distance between the electrodes.

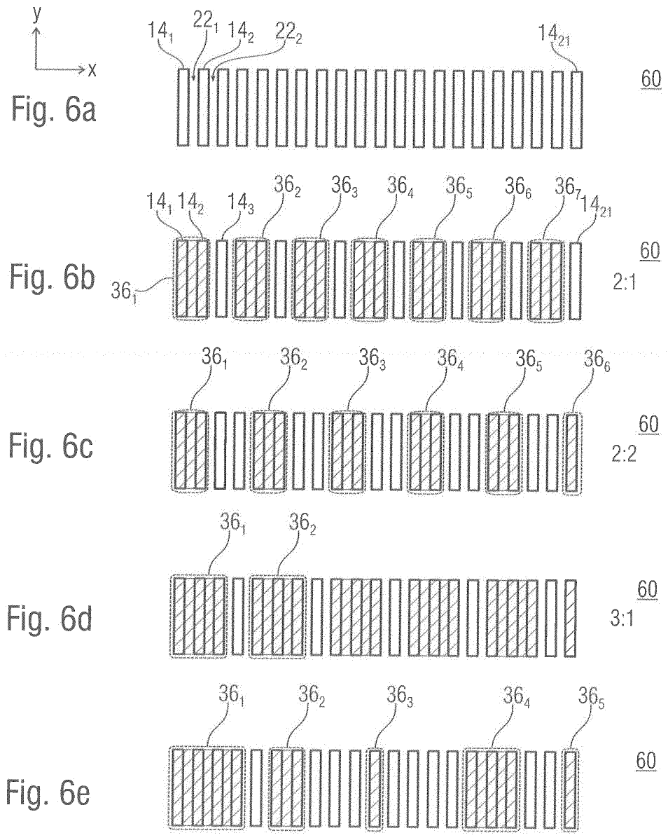

FIGS. 6a to 6e show schematic top views of an apparatus 60 according to an embodiment, wherein the apparatus 60, or the structured electrode, is formed as a bar structure with a plurality of bars. For example, the apparatus 60 comprises two, three, four, or a higher number, e.g. 21, electrode regions 14₁ to 14₂₁ that are each formed as adjacently arranged bars, i.e. a dimension along a first lateral direction, e.g. y, is at least 2 times as large, 5 times as large, or 10 times as large as a dimension along a lateral direction perpendicular thereto, e.g. x. Although the apparatus 60 is illustrated such that the electrode regions 14₁ to 14₂₁ are arranged in a single line, i.e. comprising exactly one line, a greater number of lines may be implemented, e.g. two, three, or several lines. This may be understood such that the pixel structure of FIG. 4d may be implemented with bar structures. Each of the electrode regions 14₁ to 14₂₁ may therefore define a switchable bar. The active material extending across the electrode regions and the intermediate regions is not shown.

FIG. 6a shows the apparatus 60 in a state in which the active material adjacent to all electrode regions 14₁ to 14₂₁ is colorless, e.g. it is deactivated or inactive. For example, the apparatus 60 may be used to implement a calibration standard, and is suitable for the USAF51 calibration standard. That is, the apparatus 60 may be an adjustable switchable USAF51 target. USAF51 is an optical transmission standard. It carries groups of black bars of different widths and therefore spatial frequencies on a transparent glass carrier. If these are imaged with the objective under test, the modulation transfer function and therefore the imaging quality of the objective may be determined from the contrast curves of the imaged bars of different widths. Here, an application of the present embodiments consists in placing many bar-shaped electrodes with the same width side by side (in the form of the bar-shaped structured TCO layer, electrode 14) and to then cover all bar electrodes with a continuous nanoparticle layer. As is shown in FIGS. 6b to 6e, by electrically driving the individual bars in a suitable way, an adjacent bar may also be switched. In this case, since the gaps between the bars, i.e. the intermediate regions, are also switched at the same time, the externally visible bar width between one electrode up to n electrodes may be actively varied, wherein n is the maximum number of available electrodes, in the present case 21, for example. If switched bar groups of the same width are periodically repeated along the electrode chain, the target of the USAF51 standard may be realized in a space-saving manner reduced to a small area by successively switching and imaging different bar widths. This means that the bars are temporally variable, bar groups of different widths may be actively switched, while the target for the USAF51 standard comprises all bar groups as an absorber and therefore needs a large surface area. This makes it possible to integrate an active component as a calibration standard for a lens or any other optical component so as to perform an in-situ calibration. The small spatial dimension in combination with the controllable transparency enables an integrateable design of the apparatus. Such approaches have until now always required a large-area substrate that has to accommodate all bar groups of the various spatial frequencies. Embodiments enable a temporally variable display of spatial frequencies on a surface area so that a target may be implemented in a correspondingly space-saving manner.

Even though FIGS. 6b to 6d show a periodic arrangement of the actively switched bars, non-periodic structures may be actively set along the chain/line, as is illustrated in FIG. 6e. Even though a dimension of the bar along the x-direction and the y-direction is illustrated to be identical for the electrode regions 14₁ to 14₂₁, different dimensions may be implemented according to embodiments, in particular along the x-direction. For example, a varying and/or logarithmical dimension of the electrode regions 14₁ to 14₂₁ may be selected. The bars may also be arranged in a circle, or in any other geometry. Embodiments provide gradient filters that comprise a described bar structure and are used, e.g., to control the spatial gradient response.

FIG. 6b shows the apparatus 60 in a state in which a 2:1 state is switched, i.e. two adjacent electrode regions each are actively switched, e.g. the electrode regions 14₁ and 14₂, while a subsequent electrode region, e.g. the electrode region 14₃, remains not switched.

FIG. 6c shows a schematic top view of the apparatus 60, switched in a 2:2 configuration, i.e. only one intermediate region is arranged between two adjacent simultaneously actively switched electrode regions forming a continuous absorption region 36, while a corresponding number of inactive electrode regions is arranged between two adjacent absorption regions, e.g. the absorption regions 36₁ and 36₂.

FIG. 6d shows a schematic top view of the apparatus 60 in a 3:1 configuration, wherein the absorption regions 36 each comprise three electrode regions and are spaced apart from each other by only one inactive electrode region. On the basis of a number of the total available electrode regions, what may happen with such a configuration is that one or several absorption regions have a different size, as is also shown in FIG. 6b, FIG. 6c and FIG. 6e.

FIG. 6e shows a schematic top view of the apparatus 60 within an aperiodically switched pattern, i.e. absorption regions 36₁ to 36₅ may comprise any number of electrode regions. Since, when switching adjacent electrode regions within an absorption region 36, the gaps between them are also switched at the same time, the externally visible bar width between an electrode may be actively varied to up to n electrodes, as is explained.

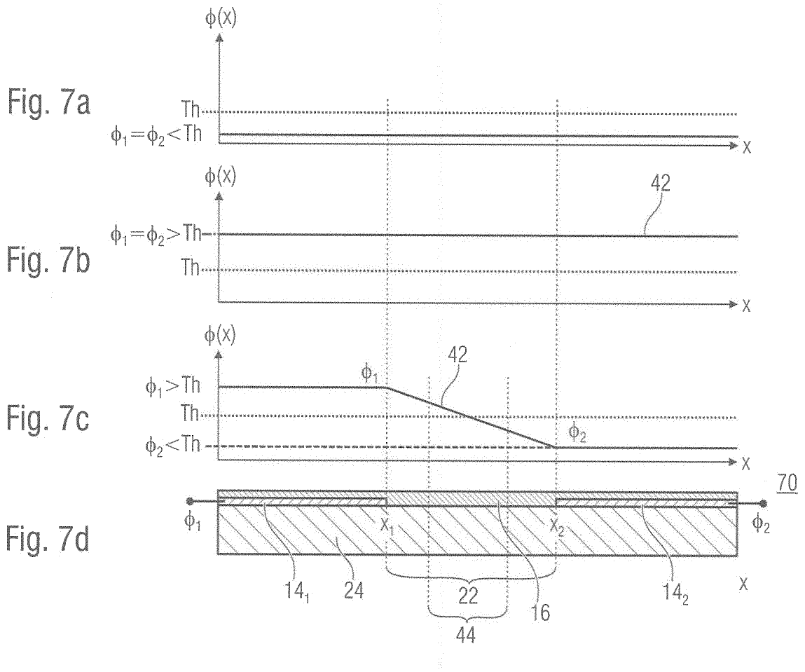

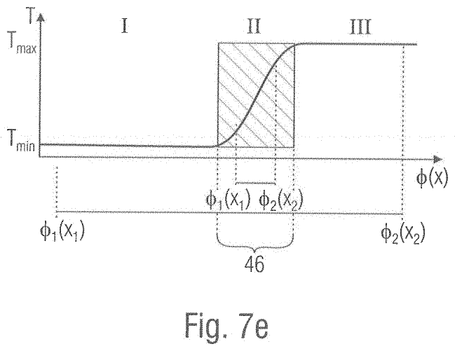

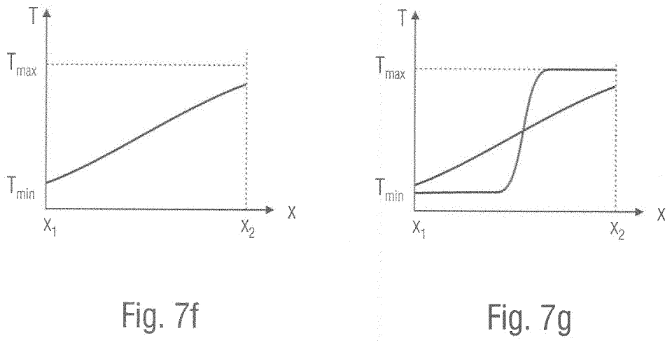

FIGS. 7a to 7c show schematic graphs of potential progression within an apparatus 70 shown in FIG. 7d in a schematic sectional side view, according to an embodiment. For the sake of simplicity, the illustration according to FIG. 7d does not include the electrode 12, so that only the electrode regions 14₁ and 14₂ arranged at the substrate 24 are illustrated, which are covered by the active material 16, where the active material 16 is further arranged in the intermediate region 22. A potential ϕ₁ may be applied to the electrode region 14₁, whereas a potential ϕ₂ may be applied at the electrode region 14₂.

According to FIG. 7a, the potentials ϕ₁ and ϕ₂ are selected such that the active material is inactive. This may be done by setting a potential difference between a potential of the working electrode and the counterelectrode such that an electrical voltage below a threshold voltage Th is obtained, the potential ϕ₁ and ϕ₂ may be adapted to the active material to this end. The active material 16 will be inactive across the entire lateral dimension x, e.g. colorless. Alternatively or additionally, materials may be used that are active at this potential, i.e. absorbing.

According to FIG. 7b, the potentials ϕ₁ and ϕ₂ are exemplarily selected to be identical and to be such that they are larger than a threshold Th, or a redox potential. The active material changes its absorption property above the threshold potential Th, e.g. by changing its color and/or its transparency. What becomes clear is that this state is achieved in the lateral progression x of the electrode regions 14₁ and 14₂. The same potential and therefore the same state as on the two electrodes arises in the intermediate region 22.

According to the configuration in FIG. 7c, the potentials ϕ₁ and ϕ₂ are both selected to be different and such that the potential ϕ₁ is above the threshold potential, and the potential ϕ₂ is below the threshold potential. Thus, the active material 16 will comprise in the region of the electrode region 14₁ the active configuration, and the inactive configuration in the region of the electrode region 14₂. There is a potential drop in the intermediate region 22, as is schematically indicated by the curve 42. If the applied or present potential falls below the threshold potential Th, the active material 16 changes its state from active to inactive across the lateral progression x.

The potentials ϕ₁ and ϕ₂ according to FIG. 7b and/or according to FIG. 7c may depend on the material, and may, e.g., have a value in a range of at least −5 volts and up to +5 volts, at least −3 volts and up to +3 volts, and at least −1 volts and up to +1 volt, e.g. 2 volts or 0.1 volt.

Adjacent to a location x, where the curve 42 is within a tolerance range of ±5%, ±10%, or ±20% in the range of the threshold potential Th, the active material 16 may configure a transition region 44 in which the active material 16 is only partially colorized so that an optical blur in the form of a spatial absorption gradient may be recognizable to the observer. The boundary 25 of FIG. 1a may be arranged in the transition region 44. With reference to FIG. 7c, the larger the difference between the potentials ϕ₁ and ϕ₂, the smaller the transition region 44, which may be perceived by the viewer as increasingly optically sharp. That is, the configured layer of the active material 16 may be configured to, at a potential difference between the first electrode region 14₁ and the electrode 12, and a second potential difference between the electrode region 14₂ and the electrode 12, configure the transition region 44, in which the absorption property changes from one of the possible states, e.g. being transparent or opaque/colorized, to another possible absorption state, e.g. being opaque/colorized and/or transparent. Such a change may be carried out in a binary manner in the sense of ON/OFF; however, it may be carried out in a multi-level manner and/or continuously within a control range, so that a plurality (at least two) or a multitude (e.g. at least three, at least four, at least 5 or more, approximately at least 10) absorption states may be set.

In the configuration according to FIG. 7a and in the configuration according to FIG. 7b, at identical potential differences, identical states are obtained in the region of the electrode regions 14₁ and 14₂ and the intermediate region 22, i.e. in the inactive state according to FIG. 7a and in the active state according to FIG. 7b. In both cases, the active material 16 comprises a homogenous absorption property across the lateral progression x across the first electrode region, the intermediate region, and the second electrode region.

FIG. 7e shows a schematic graph of a possible variation of an absorption property T across the potential ϕ(x) applied at the location x, illustrated in FIGS. 7a to 7c at the ordinate of the respective graph. The configuration illustrated in FIG. 7c, according to which the intermediate region 22 between the electrodes 14₁ and 14₂ is covered by the relatively high-resistance nanoparticle layer 16, may be driven such that an electrochemically effective potential difference (electrical voltage) may be present between the electrodes 14₁ and 14₂. This leads to the change of the optical absorption, as illustrated in FIG. 7e. For example, T denotes a transmittance so that Tₘᵢₙ may denote a colorized or absorbing state and Tₘₐₓ may denote a complementary state, e.g. being transparent. The largest absorption swing may occur in a particular electrochemical potential region 46, which is also illustrated as region II, due to the electrochromic molecules used (including the active material and possibly the electrolyte). If only a small potential difference is applied between the locations x₁ and x₂ in FIG. 7d, what results is a broad transition region of the absorption between the electrodes, as is illustrated in FIG. 7f. The iris segment, bar element, or the like might appear blurredly limited because a large width of a region 44 could arise. However, if the maximum allowed potential difference between x₁ and x₂ is applied, as is shown in FIG. 7g, the transmission curve of FIG. 7e may contract to a minimum width. The edge of the switched segment appears sufficiently sharp. According to FIG. 7g, this means that an operation with a maximum permissible voltage difference takes place. To this end, a potential difference in the range of the redox potential may be applied, so that a potential difference of at least −1500 mV and at most+1500 mV around the redox potential of the active material is obtained, e.g. in a range of ±1500 mV, ±1000 mV, or ±500 mV around the redox potential.

If the two potentials are identical, the same colorization takes place on the electrodes and the transition region, which is between Tₘᵢₙ and Tₘₐₓ depending on the potential. Thus, a neutral filter (all segments are switched) or a Fourier filter (only specific segments are switched) may also be realized.

An increasingly large potential difference between ϕ₁ and ϕ₂ enables an increasingly steeper progression of the potential drop in the curve 42 (FIG. 7c), so that an intermediate region within which the active material changes from the active to the inactive state has a small dimension along the lateral progression x (FIG. 7e), which is reflected in a steep progression of the transmission. On the other hand, if a small potential difference is set, a much broader progression of the transmission is obtained (FIG. 70. With reference to FIG. 7c, in other words, the larger the difference between the potentials ϕ₁ and ϕ₂, the smaller the transition region 44, which may be perceived by the observer as increasingly optically sharp.

A spatial progression between a first optical state, e.g. a level of absorption, and a second optical state, or level of absorption, may be set via a spatial progression of the corresponding potential differences. It is pointed out again that other optical properties may also be changed via the spatial progression. For example, considering the drive according to FIG. 4d, the transition from a maximum level of absorption to a minimum level of absorption may be between two electrode sub-regions, and may be spatially limited accordingly by applying the minimum and maximum potentials used to this end at adjacent sub-regions. Alternatively, as is shown in FIG. 4e, the transition may extend across multiple sub-regions from sub-region 14₁ to sub-region 14₉. The same applies to adjacent bars in FIGS. 6a-6d.

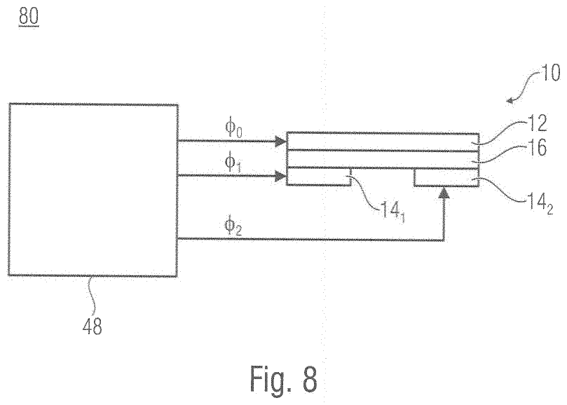

FIG. 8 shows a schematic block circuit diagram of a system 80 according to an embodiment, including the apparatus 10 and further including a drive unit 48 electrically coupled to the apparatus 10 and configured to apply an electrical potential to the electrodes 12, 14₁ and 14₂. Alternatively or additionally to the apparatus 10, another apparatus described herein may be arranged, e.g. the apparatus 20, 30, 40, 50, 60, and/or 70. The drive unit 48 may be configured to apply simultaneously a reference potential (ϕ₀), e.g. 0 volts, ground, or the like to the electrode 12. For example, the drive unit 48 may apply the potentials ϕ₁ and ϕ₂ of the configuration according to FIG. 7c to the electrodes 14₁ and 14₂. Each of the potentials ϕ₁ and ϕ₂ may be above or below the threshold potential, as is described in connection with FIG. 7c.

The drive unit 48 may be configured to apply the potentials ϕ₁ and ϕ₂ such that a transition between the first optical state in a region of the first electrode region 14₁ and a second optical state in a region of the second electrode region 14₂ is carried out in the transition region 44, wherein the transition region comprises a dimension of at most 5 μm±50%, advantageously less. This may be achieved by applying as high a potential difference ϕ₁-ϕ₂ as possible. Advantageously, the drive unit applies the potentials in such a way that a reliable continuous operation is maintained. For example, this may be obtained by applying a maximum electrical potential of the active material 16 within a tolerance range of ±20%.

The drive unit may be configured to operate the apparatus as a gradient filter, e.g. by setting the switching states of FIG. 4a and/or FIG. 4f.

An inventive method for providing an apparatus according to an embodiment includes arranging a first electrode and arranging the active material so that the active material is configured to change the absorption property on the basis of an electrical potential difference between the first electrode and a second electrode. The method includes arranging a second electrode so that the active material is arranged between the first electrode and the second electrode. The second electrode is arranged such that it comprises a structuring into at least a first electrode region and a second electrode region. An intermediate region is arranged between the first electrode region and second electrode region, so that the active material is arranged between the first electrode and the second electrode and forms a continuous layer that covers at least a sub-region of the first electrode region and a sub-region of the second electrode region, and is arranged in the intermediate region.

According to an embodiment, the active material is arranged by means of a printing method. Alternatively or additionally, a doctoring method may also be used. This means that the active material forms a continuous layer that may be solid or highly viscous, which is also distinct from a liquid used in LCD. According to embodiments described herein, the electrolyte and the active material can be arranged in different layers or distinct layers having a common boundary or contact region.

Even though some aspects have been described within the context of an apparatus, it is understood that said aspects also represent a description of the corresponding method, so that a block or a structural component of an apparatus is also to be understood as a corresponding method step or as a feature of a method step. By analogy therewith, aspects that have been described within the context of or as a method step also represent a description of a corresponding block or detail or feature of a corresponding apparatus.

The above-described embodiments merely represent an illustration of the principles of the present invention. It is understood that other persons skilled in the art will appreciate modifications and variations of the arrangements and details described herein. This is why it is intended that the invention be limited only by the scope of the following claims rather than by the specific details that have been presented herein by means of the description and the discussion of the embodiments.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Apparatus for regionally changing an optical property, comprising:
a counterelectrode;
a working electrode comprising a structuring into at least a first electrode region and a second electrode region, wherein an intermediate region is arranged between the first electrode region and the second electrode region;
an active material arranged between the counterelectrode and the working electrode and configured to change the optical property on the basis of an electrical potential difference between the counterelectrode and the working electrode;
wherein the active material forms a continuous layer that covers at least a sub-region of the first electrode region and a sub-region of the second electrode region and is arranged in the intermediate region.

2. The apparatus according to claim 1, configured to change the optical property in the intermediate region on the basis of the potential difference.

3. The apparatus according to claim 1, wherein the continuous layer of the active material is a solid layer or a highly viscous layer.

4. The apparatus according to claim 1, wherein the optical property is based on a refractive index of the active material that is variable on the basis of the electrical potential difference, comprising an absorption property or a provided phase shift, or wherein the optical property comprises a light emission.

5. The apparatus according to claim 1, wherein the active material is continuously arranged with a variable material thickness across the first electrode region, the intermediate region, and the second electrode region.

6. The apparatus according to claim 5, wherein the material thickness comprises in the intermediate region a greater material thickness than in the first and second electrode regions.

7. The apparatus according to claim 1, wherein the active material comprises nanoparticles and a multitude of electrochromic molecules that adhere to the nanoparticles, and/or wherein the active material comprises electrochromic nanoparticles and/or a combination of electrochromic nanoparticles and electrochromic molecules that adhere thereto.

8. The apparatus according to claim 1, comprising an electrolyte arranged between the active material and the counterelectrode.

9. The apparatus according to claim 1, wherein the active material is electrically conductive and is configured to, upon a first potential difference between the first electrode region and the counterelectrode and a second potential difference between the one second electrode region and the counterelectrode, configure a transition region in which the optical property switches from a first optical state into a second optical state.

10. The apparatus according to claim 9, wherein the electrolyte is arranged in at least one layer.

11. The apparatus according to claim 1, wherein the active material is configured to, upon an identical first electrical potential difference between the first electrode region and the counterelectrode on the one hand and between the one second electrode region and the counterelectrode on the other hand, comprise a homogenous first optical property across the first sub-region, the intermediate region, and the second sub-region; and
upon an identical second electrical potential difference between the first electrode region and the counterelectrode region on the one hand and between the second electrode region and the counterelectrode on the other hand, comprise a homogenous second optical property across the first sub-region, the intermediate region, and the second sub-region.

12. The apparatus according to claim 1, wherein the counterelectrode and/or the working electrode is formed to be transparently electrically conductive.

13. The apparatus according to claim 1, wherein the counterelectrode is structured or unstructured.

14. The apparatus according to claim 1, wherein the counterelectrode comprises a multitude of electrode regions that are spaced apart from one another by a plurality of intermediate regions.

15. The apparatus according to claim 1, formed as an electrochromic iris.

16. The apparatus according to claim 1, wherein the second electrode region encloses the first electrode region.

17. The apparatus according to claim 1, wherein the working electrode is structured into a multitude of electrode regions comprising the first electrode region and the one second electrode region, wherein the apparatus is formed as a pixel structure with a multitude of pixels, wherein each pixel comprises an electrode region of the multitude of electrode regions.

18. The apparatus according to claim 1, wherein the working electrode is structured into a multitude of electrode regions comprising the first electrode region and the one second electrode region, wherein the apparatus is formed as a bar structure with a multitude of bars, wherein each bar comprises an electrode region of the multitude of electrode regions.

19. The apparatus according to claim 18, wherein the apparatus is drivable as an adjustable calibration target of a calibration standard.

20. The apparatus according to claim 1, wherein the active material is configured to provide a light emission.

21. The apparatus according to claim 1, wherein the active material is configured to provide a phase shift.

22. The apparatus according to claim 1, wherein the first electrode and/or the second electrode is formed to be reflective.

23. The apparatus according to claim 1, wherein a first layer of active material is arranged at the counterelectrode, and wherein a second layer of active material is arranged at the working electrode, wherein the first layer of active material and the second layer of active material are spaced apart via an electrolyte.

24. The apparatus according to claim 23, wherein the first layer of the active material comprises a first active material and the second layer of the active material comprises a second active material, wherein the first active material and the second active material are identical or different.

25. A system, comprising:
an apparatus according to claim 1; and
a drive unit configured to apply simultaneously a reference potential to the counterelectrode, to apply a first—with respect to the reference potential—potential to the first electrode region, and to apply a second—with respect to the reference potential—potential to the second electrode region.

26. The system according to claim 25, wherein the drive unit is configured to apply the first potential and the second potential such that a transition between a first optical state in a region of the first electrode region and a second optical state in a region of the second electrode region is carried out in a transition region with a dimension of up to 5 μm±50%.

27. The system according to claim 25, wherein the drive unit is configured to apply the first potential and the second potential such that a potential difference of at least −1500 my and up to +1500 my around a redox potential of the active material is acquired.

28. The system according to claim 25, formed as an apodization filter.

29. The system according to claim 25, wherein the drive unit is configured to operate the apparatus as a gradient filter.

30. A method for providing an apparatus for regionally changing an optical property, comprising:
arranging an active material between a counterelectrode and a working electrode, comprising a structuring into at least a first electrode region and a second electrode region, so that an intermediate region is arranged between the first electrode region and the second electrode region, so that the active material is arranged between the counterelectrode and the working electrode, so that the active material is configured to change the optical property on the basis of the electrical potential differences between the counterelectrode and the working electrode;
so that the active material forms a continuous layer that covers at least a sub-region of the first electrode region and a sub-region of the second electrode region and is arranged in the intermediate region.

31. The method according to claim 30, wherein the active material is arranged by performing a printing or doctoring method.
